(19) United States
(12) Patent Application Publication
(10) Pub. No.: US 2008/0075066 A1
(43) Pub. Date: Mar. 27, 2008

(54) Presence-Based Manager of Displayable Messages

(75) Inventor: Albert J. Baker, Eatontown, NJ (US)

Correspondence Address: DEMONT & BREYER, LLC, 100 COMMONS WAY, STE 250, HOLMDEL, NJ, 07733, US

(73) Assignee: AVAYA TECHNOLOGY LLC, Basking Ridge, NJ (US)

(21) Appl. No.: 11/530,686

(22) Filed: Sep. 11, 2006

(51) Int. Cl. H04L 12/66

(52) U.S. Cl. 370/352

(57) ABSTRACT

A method is disclosed that comprises a presence-based management function that enables the intelligent routing of messages to the telecommunications endpoints of a user. The management function operates by filtering the messaging to the user's endpoints based on a series of policies around the user and system preferences for messaging, as well as on the current presence of the user at each of those endpoints. The management function resides in a proxy server. The present invention is based on the notion that instant messaging is no longer limited to client applications that run on password-protected personal computers and that, consequently, it is often undesirable to transmit an instant message to multiple endpoints of the same user.

### FIELD OF THE INVENTION

The present invention relates to telecommunications in general, and, more particularly, to determining which of multiple telecommunications endpoints are to receive a displayable message, based on one or more presence indications of their user.

### BACKGROUND OF THE INVENTION

FIG. 1 depicts telecommunications system 100 in the prior art, which system handles calls between two or more telecommunications endpoints. System 100 comprises telecommunications network 101, calling telecommunications endpoint 102, called telecommunications endpoint 103, and proxy server 104, interconnected as shown. Telecommunications system 100 operates in accordance with the Session Initiation Protocol (SIP), a set of standardized communication rules for initiating and maintaining communications for telephony, presence-based systems, instant messaging, and other telecommunications applications.

Telecommunications network 101 is a telecommunications network that comprises one or more of the Internet, the Public Switched Telephone Network (PSTN), a local area network (LAN), and so forth. Network 101 comprises or is connected to one or more transmission-related nodes such as gateways, routers, or switches that are used to direct packets from one or more sources to the correct destinations of those packets. Network 101 is capable of handling SIP-based messages that are transmitted among two or more SIP-capable processing systems.

Calling telecommunications endpoint 102 and called telecommunications endpoint 103 are SIP-capable devices such as an Internet-protocol telephone, a notebook computer, a personal digital assistant (PDA), a tablet computer, and so forth. Each endpoint is capable of originating outgoing calls and receiving incoming calls, in well-known fashion. In addition, each endpoint is capable of one or more communication modes that comprise but are not limited to voice, video, data, email, instant messaging, and chat.

One issue that exists in telecommunications system 100 relates to a particular user having additional endpoints to that user's endpoint 103. When the user has multiple endpoints, problems occur in some systems in the prior art with respect to the routing and display of instant messages. For example, some instant messaging (IM) systems operate under the assumption that a user has only a single IM client endpoint at any given time. This is not surprising, given the calling model that people often follow of calling a first device (an office phone), then a second device (a cell phone), and so forth until the party being called is reached. Consequently, the IM systems that are designed around the same model often either forcibly log off the first client endpoint when a second client endpoint registers or display warnings that messages will be displayed in multiple places.

### SUMMARY OF THE INVENTION

The present invention comprises a presence-based management function that enables the intelligent routing of messages to the telecommunications endpoints of a user. The management function operates by filtering the messaging to the user's endpoints based on a series of policies around the user and system preferences for messaging, as well as on the current presence of the user at each of those endpoints. In the illustrative embodiment, the management function resides in a proxy server.

The illustrative embodiment of present invention is based on the notion that instant messaging is no longer limited to client applications that run on password-protected personal computers and that, consequently, it is often undesirable to transmit an instant message to multiple endpoints of the same user. For example, it is quite possible to transmit an instant message to a SIP-based deskset and to have that instant message rendered on the deskset display. In fact, advanced SIP-based desksets typically comprise a sizable display area for instant messages and for other SIP-related features. Displaying instant messages on these types of desksets is analogous to a deskset automatically answering voice calls and putting them on the deskset's speaker. Clearly, it is unwise to transmit, to these types of desksets, instant messages that contain sensitive information when the user is not physically present to protect the information, as is often the case when the user has multiple endpoints.

In some embodiments, the proxy server determines whether it needs to retrieve presence data, in part by considering the kind of access protection equipped in each endpoint of the user, particularly in each endpoint's display. If the user has endpoints with minimal or nonexistent display access protection, the proxy server retrieves and considers the presence data in determining how to route the received instant message.

The proxy server of the illustrative embodiment is advantageous over some SIP proxy servers in the prior art. Some prior-art proxy servers send an instant message to each of the user's endpoints via parallel forking or to the first endpoint that accepts the message via sequential forking, without business logic or rules for determining which endpoint should receive the message. And although there are SIP standards for capabilities-based routing, in the context of the problem being addressed those standards mainly serve to prevent the instant message (IM) from going to a non-IM capable phone; the problem still exists in those prior-art systems as to what to do when the user has multiple IM-capable phones. The proxy server of the illustrative embodiment resolves these prior art limitations.

The illustrative embodiment of the present invention comprises: receiving, from a first telecommunications endpoint of a first user, an instant message that is addressed to a Session Initiation Protocol public address of a second user, wherein the instant message is received in accordance with the Session Initiation Protocol; generating a non-empty first set of contact addresses, wherein the first set is based on one or more presence indications of the second user, and wherein the contact addresses are in Session Initiation Protocol format and are associated with the public address; and transmitting the instant message to a second telecommunications endpoint that is identified by a first contact address in the filtered set of contact addresses, wherein the instant message is transmitted in accordance with the Session Initiation Protocol.

### BRIEF DESCRIPTION OF THE DRAWINGS

FIG. 1 depicts telecommunications system 100 in the prior art.

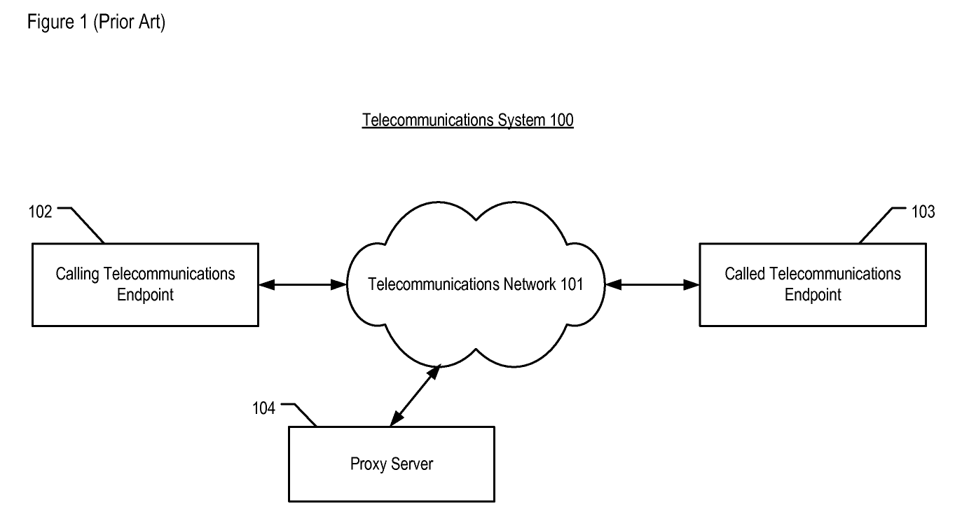

FIG. 2 depicts telecommunications system 200 with multiple telecommunications endpoints that belong to the same user, in accordance with the illustrative embodiment of the present invention.

FIG. 3 depicts the salient components of proxy server 204 of system 200.

FIG. 4 depicts a flowchart of the salient tasks performed by proxy server 204.

### DETAILED DESCRIPTION

The following term is defined for use in this Specification, including the appended claims:
The term “call,” and its inflected forms, is defined as a communication of user information between two or more telecommunications terminals. Examples of a call are a voice telephone call (including interactive voice response [IVR] sessions), an emailing, a text-based instant message [IM] session, a video conference, and so forth. In a Session Initiation Protocol (or “SIP”) context, a call is a type of session.

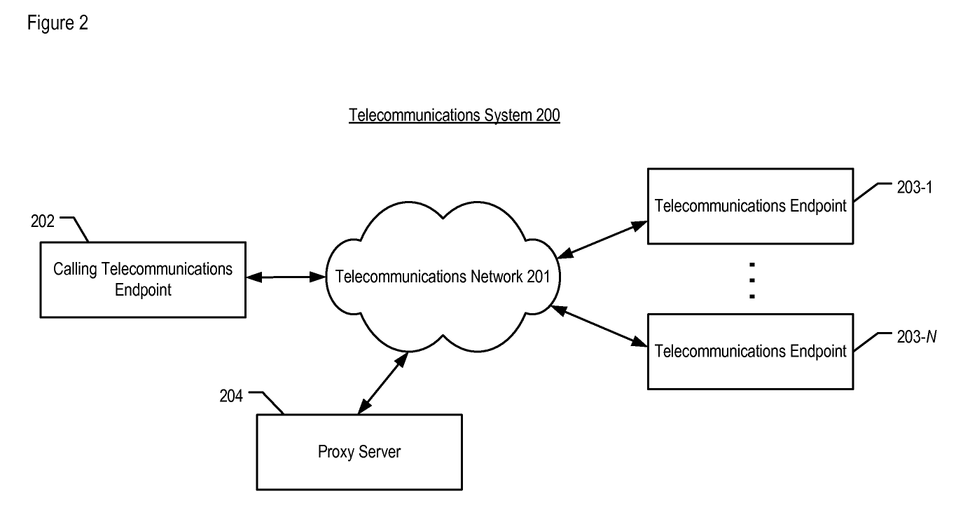

FIG. 2 depicts telecommunications system 200 in accordance with the illustrative embodiment of the present invention. Telecommunications system 200 comprises telecommunications network 201; calling telecommunications endpoint 202; telecommunications endpoints 203-1 through 203-N, wherein N is a positive integer; and proxy server 204, interconnected as shown. Telecommunications system 200 is capable of handling calls between endpoints via Session Initiation Protocol-based (SIP-based) signaling, in accordance with the illustrative embodiment. Nevertheless, it will be clear to those who are skilled in the art how to apply the present invention to some alternative embodiments that use other types of call-control signaling, such as H.323, as is known in the art.

Telecommunications network 201 is a telecommunications network that comprises one or more of the Internet, the Public Switched Telephone Network (PSTN), a local area network (LAN), and so forth. Network 201 comprises or is connected to one or more transmission-related nodes such as gateways, routers, or switches that are used to direct packets from one or more sources to the correct destinations of those packets. Network 201 is capable of handling SIP-based messages in well-known fashion that are transmitted among two or more SIP-capable processing systems.

Each of telecommunications endpoints 203-1 through 203-N, as well as calling endpoint 202, is a SIP-capable device such as an Internet-protocol telephone, a notebook computer, a personal digital assistant (PDA), a tablet computer, and so forth. Each endpoint is capable of originating outgoing calls and receiving incoming calls, in well-known fashion. In addition, each endpoint is capable of one or more communication modes that comprise but are not limited to voice, video, data, email, instant messaging, and chat. It will be clear to those skilled in the art how to make and use telecommunications endpoints 203-1 through 203-N, as well as endpoint 202.

Telecommunications endpoints 203-1 through 203-N all belong to the same user. Each endpoint 203-n, for n=1 through N, is identified by a unique contact address, as is known in the art. Moreover, the contact addresses for endpoints 203 1 through 203-N are associated with a public address of the particular user. The public address, as is known in the art, is an identifier that is used to represent the user publicly. It is an address that might, for example, appear on the user's business card. When calling parties specify the user's public address, it is up to the SIP network to resolve the address down to one or more of several endpoint devices that the user might possess. Each of endpoints 203-1 through 203-N registers its contact address and its association with a particular public address, at which point the endpoint becomes a contact for a particular user.

For example, a user named Carol Q. Jones might have a public address of cjones@company.com and four endpoints that are identified by the following contact addresses:

i. sip:cjones@111.111.111.111:5061;transport=t/s;

ii. sip:cqj@111.111.111.222:5061;transport=tls;

iii. sip:19735551212@company.com; and

iv. sip: cjones@research.company.com.

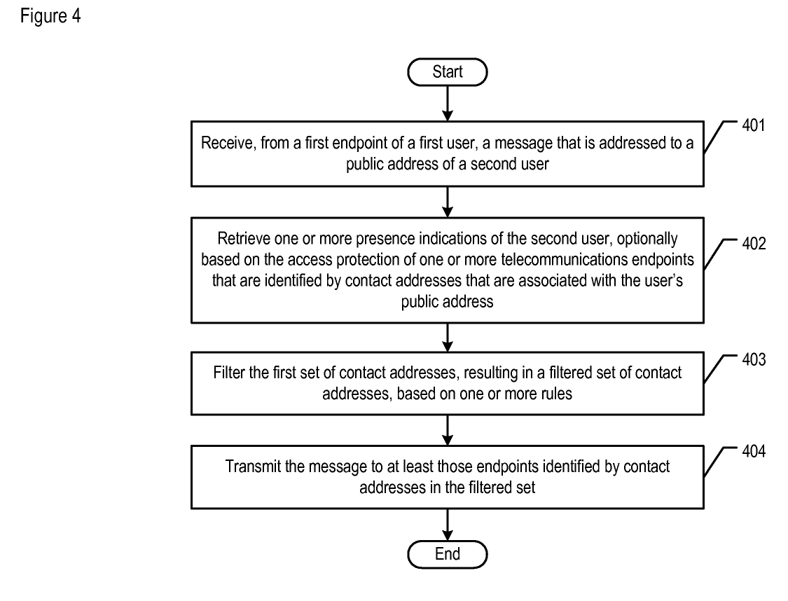

In the example, each of Carol's four endpoints is considered to be a contact for the purpose of reaching her. When Carol is called by another party, such as the user of calling endpoint 202, the public address that is used to specify the destination is cjones@company.com. System 200 routes the incoming call to one or more of endpoints 203-1 through 203-N in the manner described below and with respect to FIG. 4.

As intimated above, endpoints 203-1 through 203-N belong to a specific human user. As those who are skilled in the art will appreciate, however, endpoints 203-1 through 203-N might belong to a user that is itself a telecommunications device, such as an automated call distributor (ACD). In this case, incoming calls have as their destination address the address of the ACD system, where the individual contact addresses correspond to the various endpoints in the ACD system.

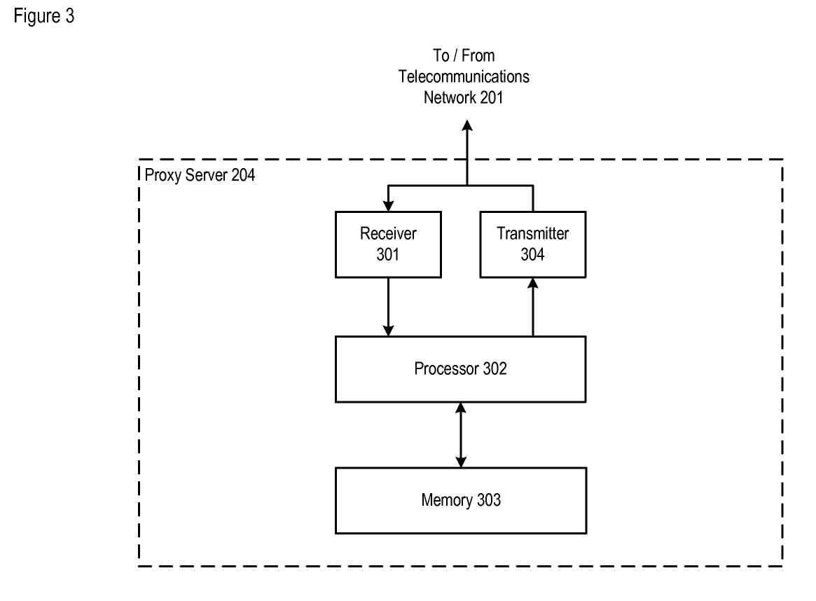

Proxy server 204 is a server that operates in accordance with the Session Initiation Protocol and that handles incoming calls (i.e., invitations to join a session) on behalf of each of the users in telecommunications system 200 to whom public addresses are assigned. The salient components of proxy server 204 are described below and with respect to FIG. 3. Proxy 204 executes the tasks described below and with respect to FIG. 4 in supporting the presence-based manager functionality of the illustrative embodiment.

Although a proxy server executes the tasks of the illustrative embodiment, in some alternative embodiments another data-processing system can be used to execute those tasks, as those who are skilled in the art will appreciate. For example, another SIP-based server (e.g., SIP feature server, etc.) can be used. In any event, it will be clear to those skilled in the art, after reading this specification, how to make and use proxy server 204.

FIG. 3 depicts the salient components of proxy server 204 in accordance with the illustrative embodiment of the present invention. Server 204 comprises receiver 301, processor 302, memory 303, and transmitter 304, interconnected as shown.

Receiver 301 is part of a network interface that receives signals from telecommunications endpoints (e.g., endpoint 202, etc.) via network 201 and forwards the information encoded in the signals to processor 302, in well-known fashion. It will be clear to those skilled in the art, after reading this specification, how to make and use receiver 301.

Processor 302 is a general-purpose processor that is capable of receiving information from receiver 301, executing instructions stored in memory 303, reading data from and writing data into memory 303, executing the tasks described below and with respect to FIG. 4, and transmitting information to transmitter 304. In some alternative embodiments of the present invention, processor 302 might be a special-purpose processor. In either case, it will be clear to those skilled in the art, after reading this specification, how to make and use processor 302.

Memory 303 stores the instructions and data used by processor 302. Memory 303 might be any combination of dynamic random-access memory (RAM), flash memory, disk drive memory, and so forth. It will be clear to those skilled in the art, after reading this specification, how to make and use memory 303.

Transmitter 304 is part of a network interface that receives information from processor 302 and transmits signals that encode this information to telecommunications endpoints (e.g., endpoint 203-n, etc.) via network 201, in well-known fashion. It will be clear to those skilled in the art, after reading this specification, how to make and use transmitter 304.

FIG. 4 depicts a flowchart of the salient tasks performed by proxy server 204, in accordance with the illustrative embodiment of the present invention. As those who are skilled in the art will appreciate, some of the tasks that appear in FIG. 4 can be performed in parallel or in a different order than that depicted.

In the illustrative scenario described, a first user, Bob Smith, wishes to transmit an instant message from that endpoint device at which he is currently active, namely telecommunications endpoint 202, to a second user, Carol Jones (from the earlier example). Carol has several endpoint devices that are capable of instant messaging, namely telecommunications endpoints 203-1 through 203-3.

Although endpoints 202 and 203-1 through 203-3 are featured in the example, the present invention can be applied to other calling endpoints and endpoints of a called party, as those who are skilled in the art will appreciate. Furthermore, illustrative embodiment features the transmission and displaying of instant messages in a Session Initiation Protocol-based (SIP-based) network. It will, however, be clear to those who are skilled in the art, after reading this specification, how to apply the present invention to the transmission and presentation of other types of messages, displayable or otherwise, in a network that is based on a different protocol than SIP.

To start the scenario, Bob sends an instant message, using endpoint 202, to Carol's public address (i.e., “cjones@company.com”). Network 201 routes the instant message to proxy server 204, the proxy server at which Carol's public address is registered.

At task 401, proxy server 204 receives, from endpoint 202, the instant message that is addressed to Carol's public address.

Server 204 then proceeds to process the received message. At task 402, server 204 recognizes that the received message is an instant message and, as such, requires special handling; as a result, server 204 retrieves presence data for Carol Jones (as represented by cjones@company.com). In some embodiments, server 204 retrieves the data from a presence server, as is known in the art. The presence data comprises one or more presence indications such as, but not limited to, the following:

i. the availability status of the user at each endpoint,

ii. the last endpoint that reported available presence, and

iii. the last endpoint that reported any activity.

In some embodiments, the retrieving of the presence data depends on the access protection of one or more telecommunications endpoints that are identified by contact addresses associated with the public address. For example, if the only endpoints that Carol has are devices with displays that have access protection (e.g., a notebook computer, etc.), then it is less important to be selective about the set of endpoints to send the message to than if Carol had devices with displays that lack access protection (e.g., a deskset in an office, etc.). As those who are skilled in the art will appreciate, in some embodiments the access protection of an endpoint can be derived from one or more other characteristics of the endpoint, such as the endpoint's device type (e.g., an Internet-protocol telephone, a notebook computer, a personal digital assistant [PDA], a tablet computer, a SIP-based deskset, etc.).

After server 204 retrieves the presence data, in some embodiments the server generates an intermediate first set of contact addresses that are based, at least in part, on the presence indications.

At task 403, server 204 filters the first set of contact addresses, based on the presence data and on one or more rules, resulting in a non-empty filtered set of one or more contact addresses. The rules specify how the instant message is to be delivered and can be any combination of user-defined rules, business rules (i.e., enterprise-defined rules), or other types of rules.

Examples of user-defined rules include:
i. routing the instant message based on time-of-day and the user's schedule.
ii. routing based on who is calling.
iii. routing based on specific preferences of the user, who in this case is Carol. For example, the user might want to have some endpoints emphasized during the workday, such as Carol's office deskset, and other endpoints emphasized during evenings and weekends, such as Carol's cell phone.

### As those who are skilled in the art will appreciate, other user-defined rules are possible.

Examples of business rules include:
i. blocking incoming messages from “1-800” telephone numbers from employees.
ii. blocking incoming messages from domain names that contain certain keywords (e.g., from known advertisers, etc.).
iii. routing based on a caller who is relevant to the overall enterprise (i.e., not just to Carol).
iv. routing based on other policies of the enterprise that apply to multiple users. For example, if the caller is well-known throughout the enterprise, a rule could be in place to send the message to all endpoints, regardless of the presence status associated with each endpoint.
v. routing to all instant message-capable devices that have a presence state set to “available.”
vi. routing to the last device that reported available presence.
vii. routing to the last device that reported activity.
   As those who are skilled in the art will appreciate, other business rules are possible. Furthermore, some rules can be considered both a business rule and a user-defined rule, except in terms of how they are defined (i.e., by the enterprise or by a user).

At task 404, server 204 transmits the instant message to those contact addresses in the filtered set of contact addresses. In the example, it turns out that exactly one contact address is in the filtered set, that of endpoint 203-1; as a result, server 204 transmits the instant message to endpoint 203-1 only. As those who are skilled in the art will appreciate, however, server 204 is capable of sending the same instant message to multiple endpoints—in parallel, in sequence, or both.

Proxy server 204 is also capable of interacting with industry-standard features such as Offline Message Retrieval. The prior-art message delivery mechanisms (e.g., Yahoo Messenger, etc.) assume that a user has a single endpoint device that the user is either present on or not present on; these mechanisms store an instant message for a user when she is not online. In the offline message retrieval feature, when the user eventually goes online, she can retrieve the missed messages. In the technique of the illustrative embodiment, the user can have multiple endpoints all online at the same time. Proxy server 204 transmits the message only to the endpoints that meet the defined rules, in accordance with the illustrative embodiment; meanwhile, the other endpoints of the user (e.g., those at which the user was not present, etc.) can get a notification that a message was read at another endpoint and cached for later viewing. In other words, some embodiments of the present invention combine what is, in essence, a “not-present” message retrieval with offline message retrieval.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed is:

1. A method comprising:
receiving, from a first telecommunications endpoint of a first user, an instant message that is addressed to a Session Initiation Protocol public address of a second user, wherein said instant message is received in accordance with the Session Initiation Protocol;
generating a non-empty first set of contact addresses, wherein said first set is based on one or more presence indications of said second user, and wherein said contact addresses are in Session Initiation Protocol format and are associated with said public address; and
transmitting said instant message to a second telecommunications endpoint that is identified by a first contact address in said filtered set of contact addresses, wherein said instant message is transmitted in accordance with the Session Initiation Protocol.

2. The method of claim 1 further comprising retrieving said one or more presence indications of said second user, based on said public address.

3. The method of claim 2 wherein the retrieving is based on the access protection of one or more telecommunications endpoints that are identified by contact addresses that are associated with said public address.

4. The method of claim 1 wherein said first set comprises those contact addresses at which said one or more presence indications indicate that said second user is available.

5. The method of claim 1 wherein said first set comprises all contact addresses associated with said public address except those that identify telecommunications endpoints with displays that lack access protection.

6. The method of claim 1 wherein said first set of contact addresses is also based on one or more rules.

7. The method of claim 6 wherein said one or more rules comprise rules that are specified by said second user.

8. The method of claim 6 wherein said one or more rules comprise rules that apply to multiple users at an enterprise, including said second user.

9. The method of claim 6 wherein the generation of said first set results in exactly one contact address in said first set of contact addresses.

10. A method comprising:
receiving, from a first telecommunications endpoint of a first user, a displayable message that is addressed to a public address of a second user;
generating a non-empty first set of contact addresses based on:
(i) one or more presence indications of said second user,
(ii) one or more rules that specify how said displayable message is to be delivered, and
(iii) said public address; and
transmitting said displayable message to a second telecommunications endpoint that is identified by a first contact address in said first set of contact addresses.

11. The method of claim 10 further comprising retrieving said one or more presence indications of said second user, wherein the retrieving is based on the access protection of one or more telecommunications endpoints that are identified by contact addresses that are associated with said public address.

12. The method of claim 10 wherein said first set comprises all contact addresses associated with said public address except those that identify telecommunications endpoints with displays that lack access protection.

13. The method of claim 10 wherein said one or more rules comprise rules that are specified by said second user.

14. The method of claim 10 wherein said one or more rules comprise rules that apply to multiple users at an enterprise, including said second user.

15. The method of claim 10 wherein said displayable message is an instant message.

16. The method of claim 15 wherein the generation of said first set results in exactly one contact address in said first set of contact addresses.

17. A method comprising:
receiving, from a first telecommunications endpoint of a first user, a displayable message that is addressed to a public address of a second user;
retrieving one or more presence indications of said second user, wherein the retrieving is based on the access protection of one or more telecommunications endpoints that are identified by contact addresses that are associated with said public address;
filtering a first set of contact addresses that are based on said one or more presence indications, resulting in a non-empty filtered set of contact addresses, wherein the filtering is based on one or more rules that specify how said displayable message is to be delivered; and
transmitting said displayable message to a second telecommunications endpoint that is identified by a first contact address in said filtered set of contact addresses.

18. The method of claim 17 wherein said public address and said contact addresses are in Session Initiation Protocol format, and wherein said contact addresses are associated with said public address, and wherein said displayable message is an instant message.

19. The method of claim 18 wherein said first set comprises those contact addresses at which said one or more presence indications indicate that said second user is available.

20. The method of claim 18 wherein said first set comprises all contact addresses associated with said public address except those that identify telecommunications endpoints with displays that lack access protection.

21. The method of claim 18 wherein the filtering of said first set results in exactly one contact address in said filtered set of contact addresses.

22. The method of claim 18 wherein said one or more rules comprise rules that are specified by said second user.

23. The method of claim 18 wherein said one or more rules comprise rules that apply to multiple users at an enterprise, including said second user.
